(19) United States
(12) Patent Application Publication
(10) Pub. No.: US 2020/0249756 A1
(43) Pub. Date: Aug. 6, 2020

(54) FINGERNAIL ATTACHABLE CAPACITIVE STYLUS

(71) Applicant: George Thomas Straza, II, La Mesa, CA (US)

(72) Inventor: George Thomas Straza, II, La Mesa, CA (US)

(21) Appl. No.: 16/696,791

(22) Filed: Nov. 26, 2019

Related U.S. Application Data
(60) Provisional application No. 62/801,411, filed on Feb. 5, 2019.

(51) Int. Cl. G06F 3/01; G06F 3/0354; G06F 3/044; A45D 31/00

(52) U.S. Cl. CPC G06F 3/014; A45D 31/00; G06F 3/044; G06F 3/03545

(57) ABSTRACT

The present application is directed to a Fingernail Attachable Capacitive Stylus to interact with any number of devices having a capacitive touch screen. More particularly, the Fingernail Attachable Capacitive Stylus device may be constructed of one or more capacitive materials pieces, then attached directly to a natural fingernail or mounted on an artificial fingernail for use in working with a capacitive touch screen such as a computer, smartphone or tablet, when the natural or artificial fingernail hinders contact with the capacitive touch screen thereon. Additionally, when in place mounted on an artificial fingernail or natural fingernail, the Fingernail Attachable Capacitive Stylus enables variable compression of the conductive material and can be adjusted for length and variable compression characteristics, and acts to strengthen long fingernails that often grow weak and subsequently easily break or crack when mounted using a natural or an artificial fingernail.

### FIELD OF THE INVENTION

This application relates to a Fingernail Attachable Capacitive Stylus to interact with any number of devices having a capacitive touch screen. More particularly, the Fingernail Attachable Capacitive Stylus device may be constructed of one or more conductive materials pieces, then attached directly to a natural fingernail or mounted on an artificial fingernail for use in working with a capacitive touch screen such as a computer, smartphone or tablet, when the natural or artificial fingernail hinders contact with the capacitive touch screen thereon. Additionally, when in place mounted on an artificial fingernail or natural fingernail, the Fingernail Attachable Capacitive Stylus can be adjusted for length and variable compression characteristics, and acts to strengthen long fingernails that often grow weak and subsequently easily break or crack when mounted using an artificial fingernail.

### BACKGROUND OF THE INVENTION

Most mobile devices in use today, including smartphones, tablets, laptops, and computer monitor screens have capacitive touch screens. Capacitive stylus devices are used with these so equipped smartphones, tablets, laptops and computer monitors. In such applications, the stylus must conduct enough electrical current and have sufficient surface area to interact with any capacitive touch screen equipped device. Electrical current is provided by contact with a user's skin. The key to providing enough electrical current for proper function is to make solid contact between the skin of the finger and the capacitive stylus device.

People with longer fingernails, those that extend beyond the end of the fingertip, often have difficulty in interacting and manipulating a capacitive touch screen panel. In the past, there have been many devices developed which enable mounting a capacitive stylus on the end of a user's finger or fingernail that in turn enables a user to interact and manipulate a capacitive touch screen equipped device. Typically, these finger attachable stylus devices do not al low the user to wear them comfortably for an extended period of time, nor do they conform to the user's changing fingernail length, especially with today's fashionable longer fingernails worn by many women. Additionally, these previously developed capacitive stylus devices do not account for the option of wearing the stylus for a prolonged period of time, as the fingernail will grow enough to eventually prevent the finger from touching and making functional contact with the capacitive device.

At the time of installation the user may decide on how much may or may not be in contact with the persons fingertip, although it must have contact with the skin when in use to provide an electrical path to the capacitive touch device. The Under Fingernail Stylus may be coated or painted with conductive or nonconductive materials as long as the coating does not interfere with the electrical path or reduce the contact surface area at the time of touching the capacitive touch device. In some cases, the person may have short fingernails where they have the capability of cutting the Under Fingernail Stylus shorter than the off the shelf product. Moreover, often the fingernails are not strong and have a tendency to crack and the additional support which comes with the addition of the artificial fingernail of the present Fingernail Attachable Capacitive Stylus helps greatly in preventing damage to the fingernail so supported.

Numerous innovations for fingernail stylists have been provided in the prior art that are described as follows. Even though these innovations may be suitable for the specific individual purposes to which they address, they differ from the present design as hereinafter contrasted. The following is a summary of those prior art patents most relevant to this application at hand, as well as a description outlining the difference between the features of the Under Fingernail Stylus and the prior art.

U.S. Pat. No. 8,730,194 B2 of Latha Sree Vallanki describes a capacitive styluses and methods for use thereof. A stylus according to the present application may include a finger engagement portion adapted to engage the finger of a user. Furthermore, the stylus may include an extension portion that is adapted to extend beyond the distal tip of the finger of the user. An electrically conductive contact surface may be disposed beyond the distal tip of the finger and be contactable with a capacitive touch panel. An electrically conductive path may be provided between the contact surface and the finger engagement portion to establish electrical communication therebetween. The contact surface may be of sufficient size to affect a capacitive sensor of a capacitive touch panel when in contact therewith and when the stylus is mounted to the finger of a user.

This patent describes a stylus device which must be worn on the finger, over the fingertip and fingernail to make contact with the skin, and does not take into account the length of the fingernail, nor does it enable long term use taking into account the subsequent growth and lengthening of the fingernail.

US Patent Application Publication No. 2005/0093835 A1 of John Renato Mortarelli describes a fingertip stylus for use in handheld computing devices is described which consists of a typical stylus tip supplemented with a contoured base that serves as a temporary, adhesive bonding interface between it and a fingertip or fingernail or both. By design the fingertip stylus is lightweight, low cost and not prone to loss or misplacement by the user. The stylus and/or the adhesive bonding surface may be implemented as single-use, disposable pointing device.

This patent discloses a fingertip stylus which is adhered to the finger and/or the fingernail to make contact with the skin, and does not take into account the length of the fingernail, nor does it enable long term use taking into account the subsequent growth and lengthening of the fingernail.

US Patent Application Publication No. 2008/0297493 A1 of Gordon K. Adkins describes a stylus for use in operating any small device requiring contact for inputting commands. The stylus is comprised of a wrap and a tip. The wrap encircles and engages a user's digit. The tip is positioned to easily contact a touch-screen device when the wrap is placed on a user's digit. The stylus is made of conductive material such that a conductive connection is made between the user's digit and the touch-screen device.

This patent teaches a capacitive stylus which connects to the digit tip by wrapping around the entire digit, not attaching to the fingernail in any way, and is primarily for use with the thumb.

US Patent Application Publication No. US 2009/0078478 of Jonathan Newman describes a flexible fingertip stylus in a variety of configurations which can be worn on one or more fingers of a user to facilitate touching keys on a keypad, keyboard, or to close, expand or minimize a window or enter other data where needed or activate portions of a screen on a touch screen device without the need to use the entire hand to hold a pen-like stylus. The device can be made of any a variety of materials including, but not limited to closed cell resin, flexible nylon, any flexible thermoplastic material, latex, plastic composites including latex, elastic, rubber, fabrics including elastic or lycra, and spandex, for example.

This patent describes and claims a stylus device which must be worn on the finger, over the fingertip and fingernail to make contact with the skin, and does not take into account the length of the fingernail, nor does it enable long term use taking into account the subsequent growth and lengthening of the fingernail.

US Patent Application Publication No. 2018/0292900 A1 of Rose M. Mercado Saddler describes a mobile phone or iPad® or notebook stylus that is glued and or adhered to the tip of the finger or the skin or the clothing (i.e. gloves) or under the fingernail for use as an alternative to “pen” and compact type styluses.

This patent discloses and teaches a stylus device which must be glued to the finger, or the fingertip and fingernail to make contact with the skin, and does not take into account the length of the fingernail, nor does it enable long term use taking into account the subsequent growth and lengthening of the fingernail.

US Patent Application Publication No. 2010/0039392 A1 of James Pratt describes a device and attachment connected to a user's fingernail that can be employed to interact with a conductive touch screen is provided. Specifically, the device is made from a conductive material and provides conductivity to the screen when in contact. The device is connected to or placed on the user's fingernail, or worn on top of the user's finger or glove. When the user touches the conductive touch screen via the device on the finger, a disturbance in capacitance is created and accordingly the presence and/or location of the finger on the screen can be detected.

This patent teaches and claims a stylus device which must be worn on top of the user's the finger or glove to make contact with the skin, and does not take into account the length of the fingernail, nor does it enable long term use taking into account the subsequent growth and lengthening of the fingernail.

U.S. Pat. No. 10,133,392 B1 of Larry Levin describes a variety of methods and compositions for a new polish formulation that uses electro-conductive liquid to transfer static electricity between the human body and a touch screen. It will be primarily used by women to uses their nails while typing. The device will bring increased speed and accuracy while being worn.

This patent describes a chemical formulation which when painted on a women's fingernails, enables capacitive touch screen functionality. It does not take into account the subsequent growth and lengthening of the fingernail which would require replacement of the nail polish at regular intervals if the device were to be worn for an extended period of time.

U.S. Pat. No. 8,970,559 B1 of Henry Lasing McVickar describes a stylus is provided with a finger engaging structure including a conductive portion for electrically contacting a finger of a user and a grasping portion for grasping the finger. The stylus has an electrically conductive stylus pad and a fingernail support element connected to the stylus pad and with a portion in contact with the fingernail of the user for positioning the stylus pad relative to the fingernail. A connection is provided from the fingernail engaging structure to the fingernail support element for electrical charge connection between the conductive portion and the stylus pad and for connecting the fingernail support to the finger engaging structure.

This patent discloses a stylus which attaches to a finger, not a fingernail, and the device includes a grasping portion for grasping the finger. It does not take into account the length of the fingernail, nor does it enable long term use taking into account the subsequent growth and lengthening of the fingernail.

U.S. Pat. No. 9,753,551 B2 of Stacey Gottlieb et al. describes a capacitive fingernail systems adapted to fit on a fingernail and for use with a capacitive touchscreen, as well as methods of creating such systems, are disclosed. The capacitive fingernail system may include a conductive base layer secured to the fingernail, a conductive upper layer, and a dielectric medium between the base and upper layers. The capacitive fingernail system stores an amount of charge that is sufficient to permit the fingernail to successfully interact with a capacitive touchscreen. Also disclosed is a fingernail stylus for use with a capacitive touchscreen, having a shaped conductive device that is pre-formed so that it can be secured to a curvature of a fingernail. The shaped conductive surface transfers an effective amount of electrical enemy to successfully interact with a capacitive touchscreen. Preferably, the capacitive fingernail systems are sized and shaped to fit unobtrusively on a fingernail without interfering with everyday activity.

This patent discloses and claims a capacitive fingernail system adapted to fit on a fingernail and for use with a capacitive touchscreen, said system comprising: a. a conductive base layer that is secured to the fingernail; b. a dielectric medium on top of the conductive base layer; and c. a conductive top layer that is located on top of the dielectric medium; wherein the capacitive fingernail system stores an effective amount of charge to permit the fingernail to successfully interact with a capacitive touchscreen. While the device is sized and shaped to fit unobtrusively on a fingernail, it does not take into account the length of the fingernail, nor does it enable long term use taking into account the subsequent growth and lengthening of the fingernail.

In this respect, before explaining at least one embodiment of the Under Fingernail Stylus in greater detail, it is to be understood that the design is not limited in its application to the details of construction and to the arrangement of the components set forth in the following description or illustrated in the drawings. The Under Fingernail Stylus is capable of other embodiments and of being practiced and carried out in various ways. Also, it is to be understood that the phraseology and terminology employed herein are for the purpose of description and should not be regarded as limiting.

### SUMMARY OF THE INVENTION

The preferred embodiment of the Fingernail Attachable Capacitive Stylus is for use under a natural or artificial fingernail to enable use, manipulation and control of a capacitive touch screen device.

The primary advantage of the Fingernail Attachable Capacitive Stylus is that it can be glued under an artificial fingernail or glued directly under the fingernail of a person using the device.

Another advantage of the Fingernail Attachable Capacitive Stylus with the use of the artificial fingernail the device increases the strength of the original fingernail where some people have thin fingernails that are easily broken.

Another advantage of the Fingernail Attachable Capacitive Stylus is that it can be worn for a prolonged period of time, even washing hands and taking baths.

Another advantage of the Fingernail Attachable Capacitive Stylus is that the preferred embodiment has a compression cavity that allows the device to work well even when the fingernail has started to grow out and get longer.

Another advantage of the Fingernail Attachable Capacitive Stylus is that it may have a glue pocket keeps the glue from spreading out when the device is installed.

Another advantage of the Fingernail Attachable Capacitive Stylus is that when the product is made of rubber, silicone or urethane foam, it will not absorb water when the person puts their hands in water.

Another advantage of the Fingernail Attachable Capacitive Stylus is that it does take into account the length of the fingernail, and it does enable long term use taking into account the subsequent growth and lengthening of the fingernail.

Another advantage of the Fingernail Attachable Capacitive Stylus is that it has a compression pocket that allows the device to provide greater surface area to better interact with a capacitive touch screen device.

Another advantage of the Fingernail Attachable Capacitive Stylus is that it may have forceps accepting grooves to help position the stylus on the artificial fingernail or natural fingernail.

These together with other advantages of the Fingernail Attachable Capacitive Stylus along with the various features of novelty, which characterize the design are pointed out with particularity in the claims annexed to and forming a part of this disclosure. For a better understanding of the Fingernail Attachable Capacitive Stylus its operating advantages and the specific objects attained by its uses, reference should be made to the accompanying drawings and descriptive matter in which there are illustrated the preferred and alternate embodiments of the Fingernail Attachable Capacitive Stylus. There has thus been outlined, rather broadly, the more important features of the design in order that the detailed description thereof that follows may be better understood, and in order that the present contribution to the art may be better appreciated. There are additional features of the Fingernail Attachable Capacitive Stylus that will be described hereinafter, and which will form the subject matter of the claims appended hereto.

The Fingernail Attachable Capacitive Stylus provides a device which has enough conductivity and sufficient surface area to interact between an end of a finger and a capacitive touch device. It is comprised of rubber, silicone or urethane foam that is impregnated with a conductive carbon or graphite material. The Fingernail Attachable Capacitive Stylus material can be injection molded, die cut or with some material being either rough cut or self-skinning foam. The Fingernail Attachable Capacitive Stylus is secured by the means of an adhesive which is the same glue used to apply artificial fingernail or similar to Loctite®, under a natural fingernail or artificial fingernail that is attached to the natural fingernail and is in contact with a person's fingertip. Before or after the Fingernail Attachable Capacitive Stylus is secured the user may modify and or contour the stylus as the user sees fit while maintaining sufficient surface area to actuate a capacitive touch device.

With respect to the above description then, it is to be realized that the optimum dimensional relationships for the parts of the Fingernail Attachable Capacitive Stylus, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present design. Therefore, the foregoing is considered as illustrative only of the principles of the Fingernail Attachable Capacitive Stylus, since numerous modifications and changes will readily occur to those skilled in the art, it is not desired to limit the Fingernail Attachable Capacitive Stylus to the exact construction and operation shown and described, and accordingly, all suitable modifications and equivalents may be resorted to falling within the scope of this application.

### BRIEF DESCRIPTION OF THE DRAWINGS

The accompanying drawings, which are incorporated in and form a part of this specification, illustrate embodiments of the Fingernail Attachable Capacitive Stylus and together with the description, serve to explain the principles of this application.

FIG. 1 depicts a side cutaway view of the preferred embodiment of the Fingernail Attachable Capacitive Stylus on a fingernail.

FIG. 2 depicts a bottom view of the preferred embodiment of the Fingernail Attachable Capacitive Stylus before inserting under the fingernail.

FIG. 3 depicts a bottom view of the preferred embodiment of the Fingernail Attachable Capacitive Stylus compressed against the finger end under a natural or artificial fingernail.

FIG. 4 depicts a bottom view of the preferred embodiment of the Fingernail Attachable Capacitive Stylus with the fingernail grown out and the Fingernail Attachable Capacitive Stylus less compressed condition but still against the end of the finger.

FIG. 5 depicts a finger and fingernail with the preferred embodiment of the Fingernail Attachable Capacitive Stylus to be moved into position.

FIG. 6 depicts the underside of the preferred embodiment of the Fingernail Attachable Capacitive Stylus on the attachment member.

FIG. 7 depicts a side cutaway view of the first alternate embodiment of the Fingernail Attachable Capacitive Stylus illustrating the compression cavity, glue pocket and with no compression pocket.

FIG. 8 depicts a bottom view of the first alternate embodiment Fingernail Attachable Capacitive Stylus illustrating the location of the glue pocket and the compression cavity.

FIG. 9 depicts a top view of the first alternate embodiment Fingernail Attachable Capacitive Stylus illustrating the compression cavity with an alternative button end.

FIG. 10 depicts a top view of a double-sided adhesive which acts as a Fingernail Attachable Capacitive Stylus attachment member to an artificial or natural fingernail.

FIG. 11 depicts the second alternate embodiment of the Fingernail Attachable Capacitive Stylus with no compression cavity, no compression pocket and adhered with double sided adhesive.

FIG. 12 depicts the second alternate embodiment of the Fingernail Attachable Capacitive Stylus that has been cut to a shorter length.

FIG. 13 depicts a bottom view of a third alternate embodiment of a single conductive material section with the Fingernail Attachable Capacitive Stylus using a cushion under a natural or artificial fingernail.

FIG. 14 depicts a bottom view of forth alternate embodiment of a single conductive material section with the Fingernail Attachable Capacitive Stylus using a coil spring under a natural or artificial fingernail.

FIG. 15 depicts a bottom view of fifth alternate embodiment of a single conductive material section with the Fingernail Attachable Capacitive Stylus using a leaf spring under a natural or artificial fingernail.

FIG. 16 depicts a bottom view of the sixth alternate embodiment of a single conductive material section with the Fingernail Attachable Capacitive Stylus using a spring against the end of the finger under a natural or artificial fingernail.

FIG. 17 depicts a bottom view of another embodiment of a conductive material section with the Fingernail Attachable Capacitive Stylus moved away from the end of the finger loosing contact with the device.

FIG. 18 depicts a bottom view of a seventh alternate embodiment of a two-piece conductive material section of the Fingernail Attachable Capacitive Stylus using a spring between the two pieces of conductive material under a natural or artificial fingernail.

FIG. 19 depicts a bottom view of a two-piece lap connection of the conductive material section with the Fingernail Attachable Capacitive Stylus under a natural or artificial fingernail.

FIG. 20 depicts a bottom view of a two-piece butt connection of the conductive material section with the Fingernail Attachable Capacitive Stylus under a natural or artificial fingernail.

FIG. 21 depicts a side cutaway view of a Fingernail Attachable Capacitive Stylus with a two-piece construction using an overlap method of connecting the pieces together underneath the finger end and fingernail.

FIG. 22 depicts a side cutaway view of a Fingernail Attachable Capacitive Stylus with a two-piece construction using a butt method of connecting the pieces together underneath the finger end.

FIG. 23 depicts a side cutaway view of a Fingernail Attachable Capacitive Stylus with a one-piece construction using a direct method of connecting the pieces together underneath the finger end and fingernail using adhesive and an artificial fingernail, illustrating that the Fingernail Attachable Capacitive Stylus of the present invention may have a pointed tip.

FIG. 24 depicts a side cutaway view of a Fingernail Attachable Capacitive Stylus with a one-piece construction using a direct method of connecting the pieces together underneath the finger end and fingernail or an artificial nail using adhesive, illustrating that the Fingernail Attachable Capacitive Stylus of the present invention may have forceps accepting grooves and a bulbous end including a compression pocket.

FIG. 25 depicts a top and side perspective vim of a Fingernail Attachable Capacitive Stylus with a one-piece construction, illustrating that the Fingernail Attachable Capacitive Stylus of the present invention showing a compression cavity.

FIG. 26 depicts a bottom and side perspective view of a Fingernail Attachable Capacitive Stylus with a one-piece construction, illustrating that the Fingernail Attachable Capacitive Stylus of the present invention with forceps grooves.

FIG. 27 depicts a bottom view of a Fingernail Attachable Capacitive Stylus with a one-piece construction, illustrating that the Fingernail Attachable Capacitive Stylus of the present invention may have forceps grooves and a bulbous end.

FIG. 28 depicts a side cutaway view of a Fingernail Attachable Capacitive Stylus with a two-piece construction using a direct method of connecting the pieces together underneath the finger end and fingernail or an artificial nail using adhesive, illustrating that the Fingernail Attachable Capacitive Stylus of the present invention may have forceps grooves incorporated into both pieces and a bulbous end including a compression pocket.

FIG. 29 depicts a bottom view of a Fingernail Attachable Capacitive Stylus with a two-piece construction, illustrating that the Fingernail Attachable Capacitive Stylus of the present invention may have forceps grooves in each piece and a bulbous end including a compression pocket.

FIG. 30 depicts a side cutaway view of a Fingernail Attachable Capacitive Stylus with a two-piece construction using a direct method of connecting the pieces together underneath the finger end and fingernail or an artificial nail using adhesive, illustrating that the Fingernail Attachable Capacitive Stylus of the present invention may have compression cavity, forceps grooves incorporated into both pieces and a bulbous end including a compression pocket.

FIG. 31 depicts a side cutaway view of a Fingernail Attachable Capacitive Stylus with a one-piece construction, using a direct method of connecting the pieces together underneath the finger end and fingernail or an artificial nail using adhesive, illustrating that the Fingernail Attachable Capacitive Stylus of the present invention may have forceps accepting grooves and a bulbous end including a hollow compression pocket.

FIG. 32 depicts a side cutaway view of a Fingernail Attachable Capacitive Stylus with a two-piece construction using a direct method of connecting the pieces together underneath the finger end and fingernail or an artificial nail using adhesive, illustrating that the Fingernail Attachable Capacitive Stylus of the present invention may have forceps accepting grooves in each piece and a bulbous end including a hollow compression pocket.

FIG. 33 depicts a side cutaway view of a Fingernail Attachable Capacitive Stylus with a one-piece construction using a direct method of connecting the piece underneath the finger end and fingernail or an artificial nail using adhesive, illustrating that the Fingernail Attachable Capacitive Stylus of the present invention may have compression cavity, forceps grooves incorporated into the one-piece and a bulbous end including a hollow compression pocket.

FIG. 34 depicts a side cutaway view of a Fingernail Attachable Capacitive Stylus with a two-piece construction using a direct method of connecting the pieces together underneath the finger end and fingernail or an artificial nail using adhesive, illustrating that the Fingernail Attachable Capacitive Stylus of the present invention may have compression cavity, forceps grooves incorporated into both pieces and a bulbous end including a hollow compression pocket.

### DETAILED DESCRIPTION OF THE PREFERRED EMBODIMENTS

As required, the detailed embodiments of the present Fingernail Attachable Capacitive Stylus 10A through 10X are disclosed herein, however, it is to be understood that the disclosed embodiments are merely exemplary of the design that may be embodied in various forms. Therefore, specific functional and structural details disclosed herein are not to be interpreted as limiting, but merely as basic for the claims and as a representative basis for teaching one skilled in the art to variously employ the present design in virtually any appropriately detailed structure as well as combination.

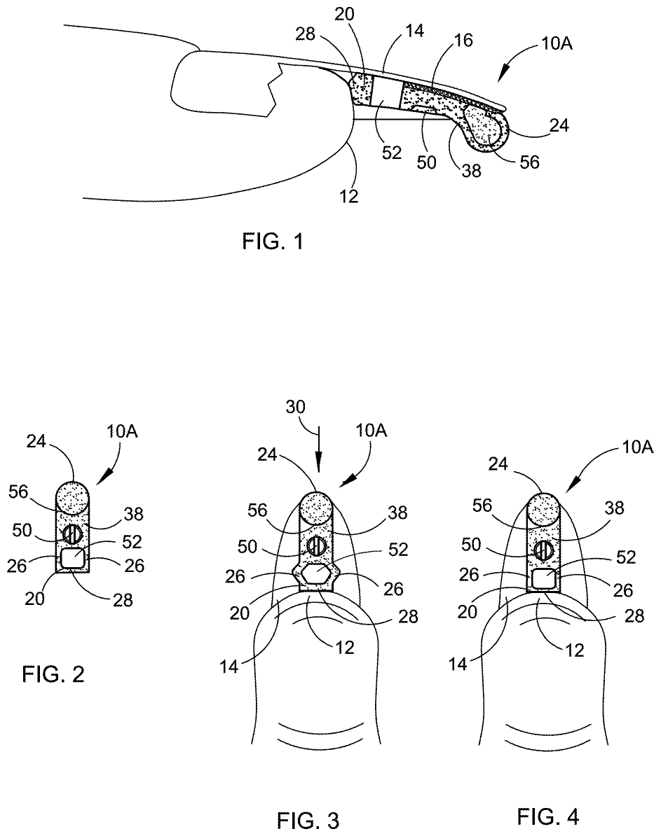

FIG. 1 depicts a side cross section view of the Fingernail Attachable Capacitive Stylus 10A abutting the finger end 12 with the artificial fingernail 14 extending outwardly. The Fingernail Attachable Capacitive Stylus 10A is adhesively attached by means of glue or adhesive material 16 to the artificial fingernail 14 where the Fingernail Attachable Capacitive Stylus 10A extended end 20 can flex by the means of the compression cavity 52 when the fingernail 13 grows out. The conductive material can take the form of an amorphous bulbous end 24, here shown having a compression pocket 56 therein, of the Fingernail Attachable Capacitive Stylus 10A.

FIG. 2 depicts a top plan view of the Fingernail Attachable Capacitive Stylus 10A in the retracted condition where the compression spring action sides 26 are pulled into the compression cavity 52 and the finger-tip skin contacting proximal end 20 of the Fingernail Attachable Capacitive Stylus 10A makes contact with the user's finger along the conductive material distal end 28.

FIG. 3 depicts a top plan view of the Fingernail Attachable Capacitive Stylus 10A pressed down 30 to expand the compression cavity 52 where the compression spring action sides 26 are spread out and the length is shortened and the proximal end 20 (that end of the Fingernail Attachable Capacitive Stylus 10A closest to the fingertip) is held against the finger end 12 along curved portion 28 when the Fingernail Attachable Capacitive Stylus 10A device is glued 14 in place on the artificial fingernail 16.

FIG. 4 depicts a top plan view of the Fingernail Attachable Capacitive Stylus 10A where the artificial fingernail 14 has grown out creating less compression 26, but the contact still remains between the finger-tip skin contacting proximal end 20 curved portion 28 of the conductive material of the Fingernail Attachable Capacitive Stylus 10A device and the finger end 12 and the compression spring action sides 26 are pulled into the compression cavity 22.

FIG. 5 depicts a perspective view of the artificial fingernail 14 and the Fingernail Attachable Capacitive Stylus 10A before it being inserted in the direction of the artificial fingernail insertion arrow 17 under the artificial fingernail 14. This view also illustrates the position of the glue or adhesive material 16 between the artificial fingernail and the conductive material 38 having a bulbous end 24.

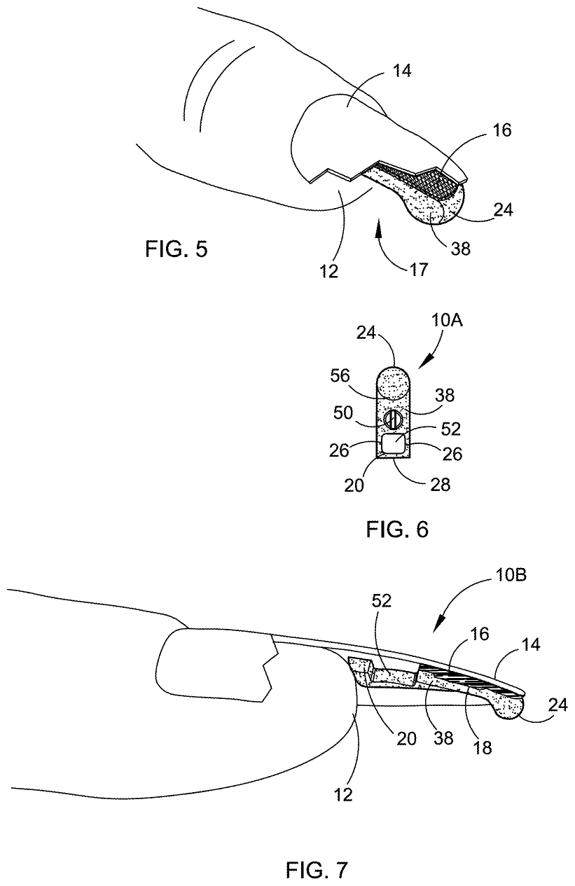

FIG. 6 depicts a perspective view of the underside of the Fingernail Attachable Capacitive Stylus 10A and the artificial fingernail 14 illustrating the location of the compression cavity 52, the finger-tip skin contacting proximal end 20 and distal end touch screen contacting conductive material here having a bulbous end 24. The Fingernail Attachable Capacitive Stylus 10A is mounted on the underside of the artificial fingernail 14 (see artificial fingernail insertion arrow 17 of FIG. 5).

FIG. 7 depicts a side cross section view of the Fingernail Attachable Capacitive Stylus 10B abutting the finger end 12 with the artificial fingernail 14 extending outwardly. The Fingernail Attachable Capacitive Stylus 10A is adhesively attached by means of glue 16 to the artificial fingernail 14 by means of glue in the glue pocket 18 where the Fingernail Attachable Capacitive Stylus 10A extended end 20 can flex by the means of the compression cavity 52 when the fingernail 13 grows out. The conductive material can take the form of an amorphous bulbous end 24 (here shown with no compression pocket) of the Fingernail Attachable Capacitive Stylus 10B.

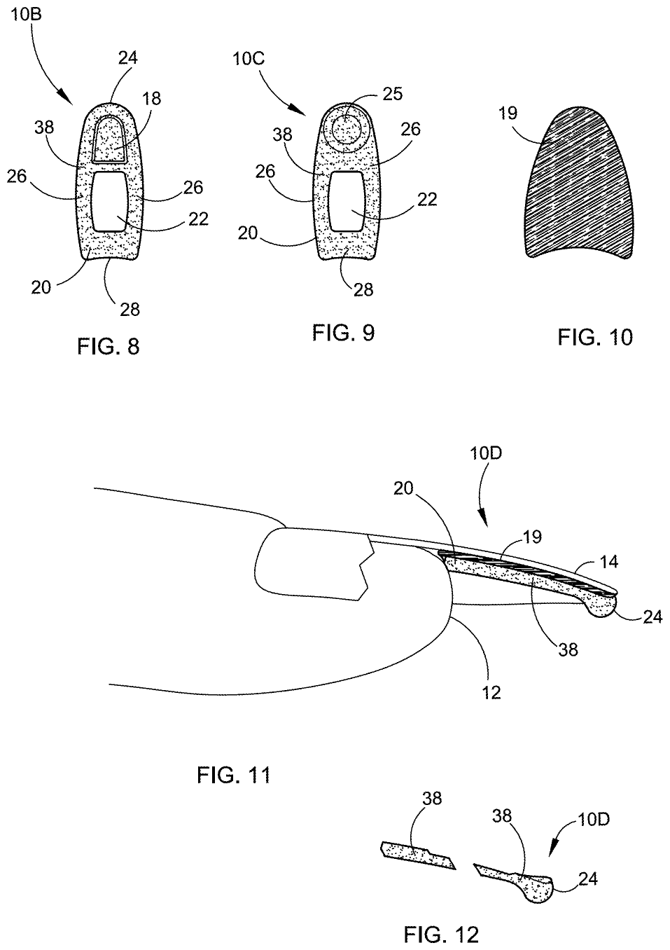

FIG. 8 depicts a top plan view of the Fingernail Attachable Capacitive Stylus 10B illustrating the location of the adhesive holding glue pocket 18 and the compression spring action sides 26 of the compression cavity 22, the finger-tip skin contacting proximal end 20, and the bulbous end 24 of the device, located on the distal end of the Fingernail Attachable Capacitive Stylus 10B.

FIG. 9 depicts a bottom plan view of the Fingernail Attachable Capacitive Stylus 10C illustrating the location of the compression spring action sides 26 of the compression cavity 22. This Fingernail Attachable Capacitive Stylus 10A is made from a single piece of conductive material having a finger-tip skin contacting proximal end 20 and having a button end 25.

FIG. 10 depicts a top plan view of double-sided adhesive 19 which may be used with the Fingernail Attachable Capacitive Stylus 10D (see FIG. 11 below). This double-sided adhesive 19 may also be used to mount any one of the various Fingernail Attachable Capacitive Stylus disclosed herein (see FIGS. 11-12).

FIG. 11 depicts a side cross section view of the Fingernail Attachable Capacitive Stylus 10D abutting the finger at the conductive material proximal finger contact end 20 with the artificial fingernail 14 extending out and adhesively attached to the artificial fingernail 14 by the means of double-sided adhesive 19 to support the one-piece conductive material which can be cut to the proper length, here having an end shaped in the form of a bulbous end 24.

FIG. 12 depicts a cross section of the Fingernail Attachable Capacitive Stylus 10D that has had the one-piece conductive material with glue pocket 18, and shaped into a bulbous end 24, cut in two pieces in order to shorten the Fingernail Attachable Capacitive Stylus 10D to the proper length for use. In operation, the Fingernail Attachable Capacitive Stylus 10D can be removed from the artificial fingernail 14 and cut to size as desired, then re-adhered to the artificial fingernail 14. In this way, the Fingernail Attachable Capacitive Stylus 10D is size adjustable to take into account the growth (lengthening) or trimming (shortening) of the natural fingernail.

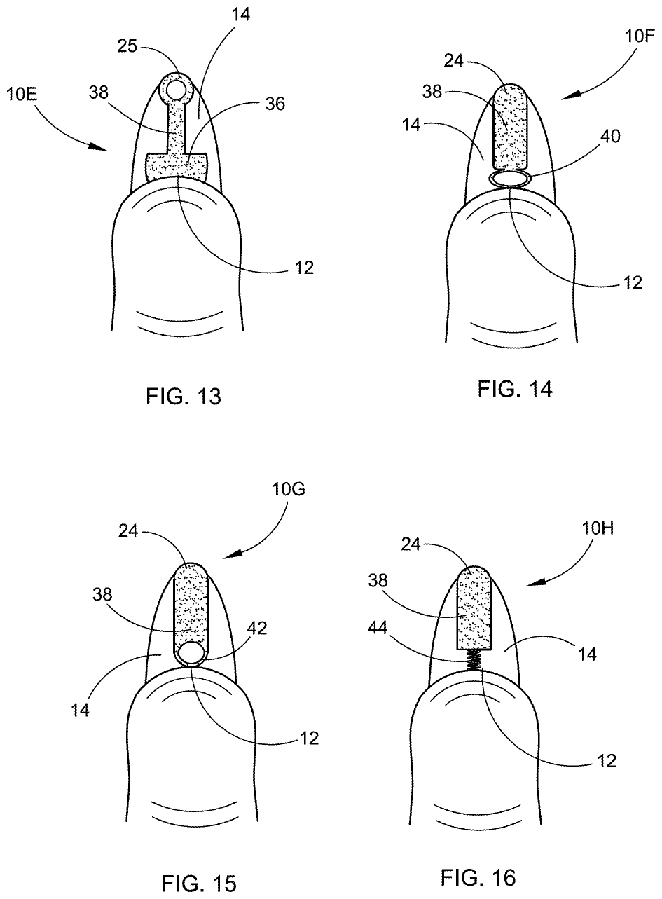

FIG. 13 depicts a bottom view of the Fingernail Attachable Capacitive Stylus 10E having a one-piece large compressible finger skin contact portion for contact with the finger end 12. It illustrates the conductive material 38 secured under a natural or artificial fingernail 14. The Fingernail Attachable Capacitive Stylus 10E may be in contact with the persons finger end 12, thus the user may define the amount of compression using the conductive material 38, here shaped as a larger expanded compressible finger skin contact portion cushion 36 on the finger end 12 but will need to be in contact with the skin when in use to provide an electrical path to the Fingernail Attachable Capacitive Stylus 10E. On the distal end of the device is the conductive material 38 shaped into a button end 25.

FIG. 14 depicts bottom view of a one-piece spring loaded Fingernail Attachable Capacitive Stylus 10F underneath the finger end 12 and fingernail 14. It shows the conductive material 38 secured in anyway, under a natural or artificial fingernail 14. The Fingernail Attachable Capacitive Stylus 10F may be in contact with the persons finger end 12, thus the user may define the amount of compression of the conductive material 38 using the integrated oval-shaped spring material 40 as a cushion on the finger end 12, as it will need to be in contact with the skin when in use to provide an electrical path to the capacitive touch device. On the distal end of the device is the conductive material 38 shaped into a bulbous end 24.

FIG. 15 depicts a bottom view of another one-piece spring-loaded Fingernail Attachable Capacitive Stylus 10G underneath the finger and fingernail. It shows the conductive material 38 secured in anyway, under a natural or artificial fingernail 14. The Fingernail Attachable Capacitive Stylus 10G may be in contact with the persons finger end 12, so that the user may define the amount of compression using the conductive material 38 formed into a round-shaped spring 42 as a cushion on the finger end 12 that will need to be in contact with the skin when in use to provide an electrical path to the Fingernail Attachable Capacitive Stylus 10G. On the distal end of the device is the conductive material 38 shaped into a bulbous end 24.

FIG. 16 depicts bottom view of a two-piece spring loaded Fingernail Attachable Capacitive Stylus 10H underneath the finger end 12 and fingernail 14 that shows the conductive material 38 secured in anyway, under a natural or artificial fingernail 14. The Fingernail Attachable Capacitive Stylus 10H may be in contact with the persons finger end 12, thus the user may define the amount of compression using the conductive material 38 formed into a spring 44 in contact with the user's finger end 12. The spring 44 will need to be in contact with the skin when in use to provide an electrical path to the Fingernail Attachable Capacitive Stylus 10H. On the distal end of the device is the conductive material 38 shaped into a bulbous end 24.

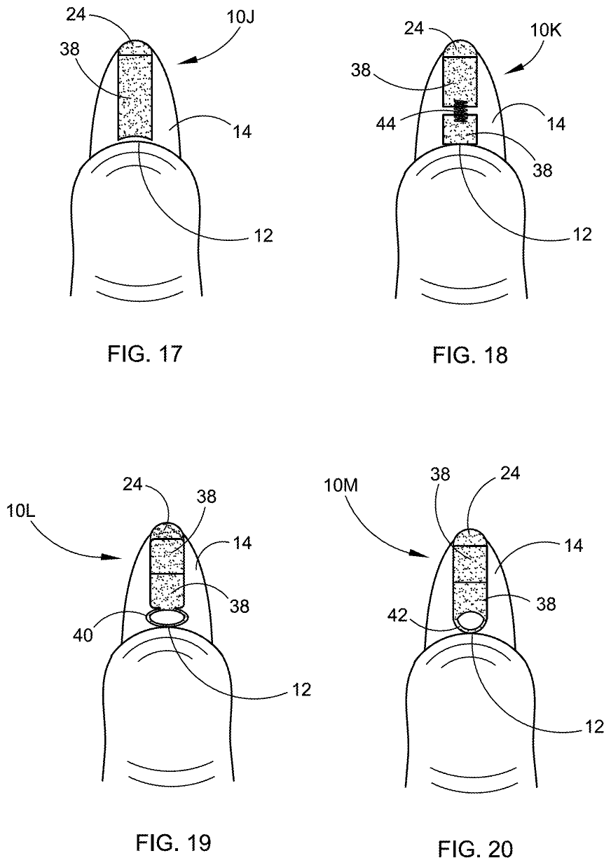

FIG. 17 depicts bottom view of a two-piece spring loaded Fingernail Attachable Capacitive Stylus 103 underneath the natural fingernail or an artificial fingernail 14 and in contact with the user's finger end 12. It shows a single piece of the conductive material 38 in the form of a compressible urethane or rubber foam or the like, along with a single piece of conductive material forming a bulbous end 24, secured under a natural fingernail or artificial fingernail 14. The stylus may be in contact with the persons finger end 12 so that the user may define the amount of compression using the inherent spring characteristics of the conductive material 38 coupled to the bulbous end 24. Again, the finger contacting end 12 will need it to be in contact with the user's skin when in use to provide an electrical path to the Fingernail Attachable Capacitive Stylus 10J. On the distal end of the device the conductive material 38 is shaped into a bulbous end 24.

FIG. 18 depicts another bottom view of a four-piece spring-loaded Fingernail Attachable Capacitive Stylus 10K with a four-piece construction in contact with a user's finger end 12. It shows the conductive material 38 split into two adjustable length pieces and spanned by a conductive material spring piece 44, secured under a natural fingernail or an artificial fingernail 14. The Fingernail Attachable Capacitive. Stylus 10K must be in contact with the persons finger end 12 so that the user may define the amount of compression using the conductive material 38 in combination with the spring piece 44. Opposite the finger end 12 will be located a conductive material having a bulbous end 24. The conductive material is held in contact with the skin when in use to provide an electrical path from the user's skin to the Fingernail Attachable Capacitive Stylus 10K.

FIG. 19 depicts bottom view of a three-piece spring loaded Fingernail Attachable Capacitive Stylus 10L having a three-piece conductive material 38 construction mounted under a natural fingernail or an artificial fingernail 14 and in contact with the user's finger end 12 using an oval-shaped spring mechanism 40 located at the proximal end of the device in contact with the fingertip end 12. The Fingernail Attachable Capacitive Stylus 10L must be in contact with the persons finger end 12 so that the user may define the amount of compression using the conductive material 38 in combination with the spring 40 mechanism located at the proximal end of the device in contact with the fingertip. Opposite the finger end 12 will be located a conductive material having a bulbous end 24. The conductive material is held in contact with the skin when in use to provide an electrical path from the user's skin to the Fingernail Attachable Capacitive Stylus 10L.

FIG. 20 depicts another bottom view of a three-piece spring loaded Fingernail Attachable Capacitive Stylus 10M having a three-piece conductive material 38 construction, mounted under a natural fingernail or an artificial fingernail 14 and in contact with the finger end 12 using a round shaped spring mechanism 42 located at the proximal end of the device in contact with the fingertip end 12. The Fingernail Attachable Capacitive Stylus 10M must be in contact with the persons finger end 12 so that the user may define the amount of compression using the conductive material 38 in combination with the spring 42 mechanism located at the proximal end of the device in contact with the fingertip. Opposite the finger end 12 will be located a conductive material having a blunt or bulbous end 24. The conductive material is held in contact with the skin when in use to provide an electrical path from the user's skin to the Fingernail Attachable Capacitive Stylus 10M.

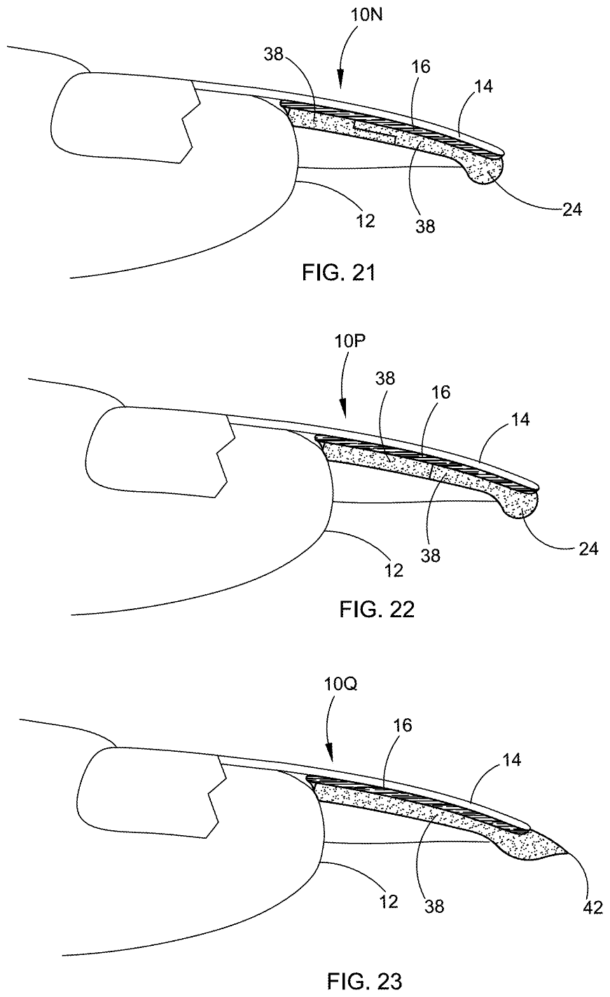

FIG. 21 depicts a side cutaway view of a two-piece spring loaded Fingernail Attachable Capacitive Stylus 10N with a two-piece construction having a central overlapping connection of the two pieces of conductive material 38 together mounted to make contact with the finger end 12 and mounted under a natural fingernail or an artificial fingernail 14. The Fingernail Attachable Capacitive Stylus 10N must be in contact with the persons finger end 12 so that the user may define the amount of compression using the conductive material 38 of the device in contact with the fingertip. Opposite the finger end 12 will be located a conductive material bulbous end 24. The conductive material is held in contact with the skin when in use to provide an electrical path from the user's skin to the Fingernail Attachable Capacitive Stylus 10N. By using and mounting differing sizes and adjusting the lengths of the two pieces of conductive material 38, the user can account for fingernail growth and continue to use the Fingernail Attachable Capacitive Stylus 10N for prolonged periods of time.

FIG. 22 depicts a side cutaway view of a two-piece spring loaded Fingernail Attachable Capacitive Stylus 10P with a two-piece construction having a central butting connection of the two pieces of conductive material 38 together mounted underneath the finger end 12 and mounted under a natural fingernail or an artificial fingernail 14. The Fingernail Attachable Capacitive Stylus 10P must be in contact with the persons finger end 12 so that the user may define the amount of compression using the conductive material 38 in contact with the fingertip. Opposite the finger end 12 will be located a conductive material bulbous end 24. The conductive material is held in contact with the skin when in use to provide an electrical path from the user's skin to the Fingernail Attachable Capacitive Stylus 10P. By using and mounting differing sizes and adjusting the lengths of the two pieces of conductive material 38, the user can account for fingernail growth and continue to use the Fingernail Attachable Capacitive Stylus 10P for prolonged periods of time.

FIG. 23 depicts a side cutaway view of a one-piece spring loaded Fingernail Attachable Capacitive Stylus 10Q with a one-piece construction having an extended piece of conductive material 38 together mounted under a natural fingernail or an artificial fingernail 14 and in contact with the user's finger end 12. The Fingernail Attachable Capacitive Stylus 10Q must be in contact with the user's finger end 12 so that the user may define the amount of compression using the conductive material 38 in contact with the fingertip. Opposite the finger end 12 will be located a conductive material sharp pointed end 42. The conductive material is held in contact with the skin when in use to provide an electrical path from the user's skin to the Fingernail Attachable Capacitive Stylus 10Q. By using and mounting differing sizes and adjusting the lengths of the single piece of conductive material 38, the user can account for fingernail growth and continue to use the Fingernail Attachable Capacitive Stylus 10Q for prolonged periods of time.

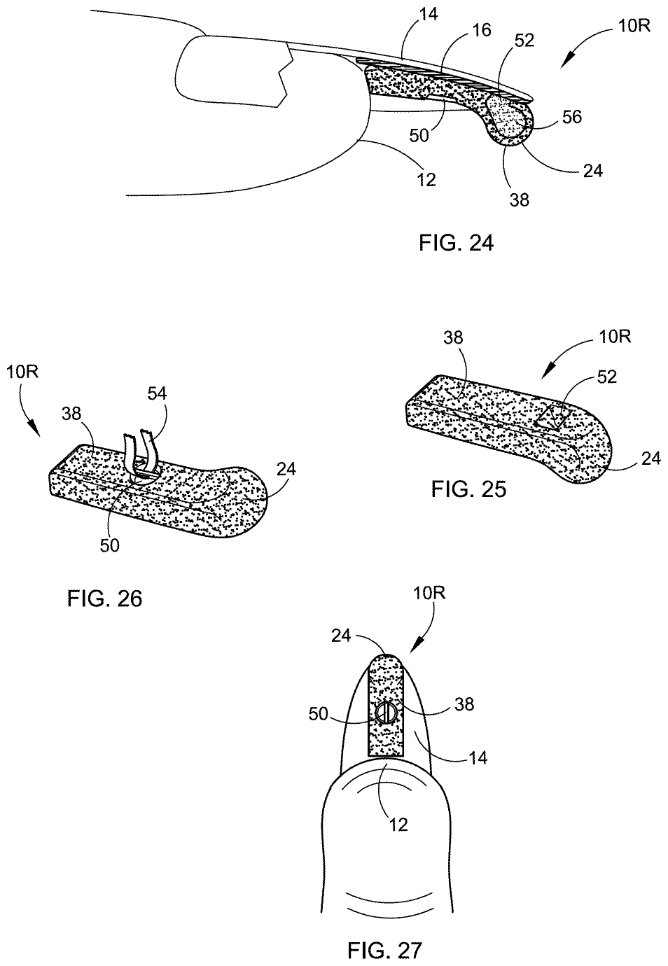

FIG. 24 depicts a side cutaway view of a Fingernail Attachable Capacitive Stylus 10R with a one-piece construction using a direct method of connecting the conductive material piece 38 underneath the finger end 12 and fingernail or an artificial fingernail using adhesive 16. The Fingernail Attachable Capacitive Stylus 10R of the present invention may have forceps accepting grooves 50 and a bulbous end 24 including a compression pocket 56. The forceps grooves allow for a user to apply and remove the Fingernail Attachable Capacitive Stylus 10R. The bulbous end 24 with compression cavity 56 allows for differing pressure on contact between the device capacitive touch screen (not shown) and the conductive material 38.

FIG. 25 depicts a top and side perspective view of a Fingernail Attachable Capacitive Stylus 10R with a one-piece construction, illustrating that the Fingernail Attachable Capacitive Stylus of the present invention showing a compression cavity 52 therein. The compression cavity 52 acts to compensate for differing pressure applied to the device capacitive touch screen (not shown) and the conductive material 38 by being flexible in the area of the compression cavity 52. Thus, a hollow bulbous end (see FIG. 24) is used in this configuration.

FIG. 26 depicts a bottom and side perspective view of a Fingernail Attachable Capacitive Stylus 10R with a one-piece construction, illustrating that the Fingernail Attachable Capacitive Stylus of the present invention may have forceps grooves 50, here shown with forceps tips 54 inserted into the forceps grooves 50. These forceps grooves are used when the Fingernail Attachable Capacitive Stylus 10R device is inserted onto a fingernail, or removed therefrom.

FIG. 27 depicts a bottom view of a Fingernail Attachable Capacitive Stylus 10R with a one-piece construction, illustrating that the Fingernail Attachable Capacitive Stylus 10R may have forceps grooves 50 and a bulbous end 24 incorporated into the conductive material 38.

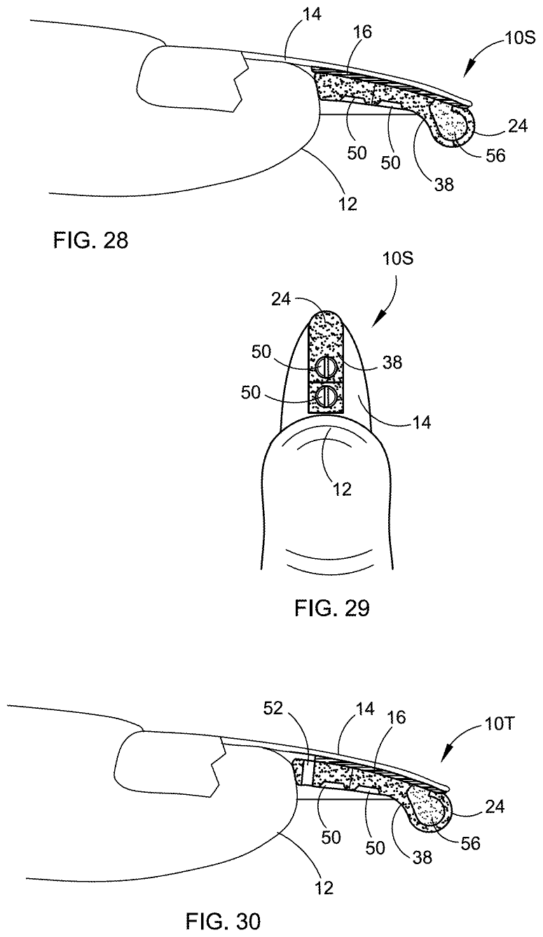

FIG. 28 depicts a side cutaway view of a Fingernail Attachable Capacitive Stylus 10S with a two-piece construction using a direct method of connecting the pieces together underneath the finger end 12 and fingernail or an artificial nail 14 using adhesive, illustrating that the Fingernail Attachable Capacitive Stylus 10S of the present invention may have forceps grooves 50 incorporated into both pieces of conductive material 38, and a bulbous end 24 including a compression pocket 56.

FIG. 29 depicts a bottom view of a Fingernail Attachable Capacitive Stylus 10S with a two-piece construction, illustrating that the Fingernail Attachable Capacitive Stylus 10S of the present invention may have forceps grooves 50 in each piece and a bulbous end 24 including a compression pocket 52 which cannot be seen in this bottom view because it does not extend all the way through the conductive material 38.

FIG. 30 depicts a side cutaway view of a Fingernail Attachable Capacitive Stylus 10T with a two-piece construction using a direct method of connecting the pieces together underneath the finger end 12 and fingernail or an artificial nail 14 using adhesive 16, illustrating that the Fingernail Attachable Capacitive Stylus 10T of the present invention may have a compression cavity 52 located near the fingertip, forceps grooves 50 incorporated into both pieces and a bulbous end 24 including a compression pocket 56 in the conductive material 38.

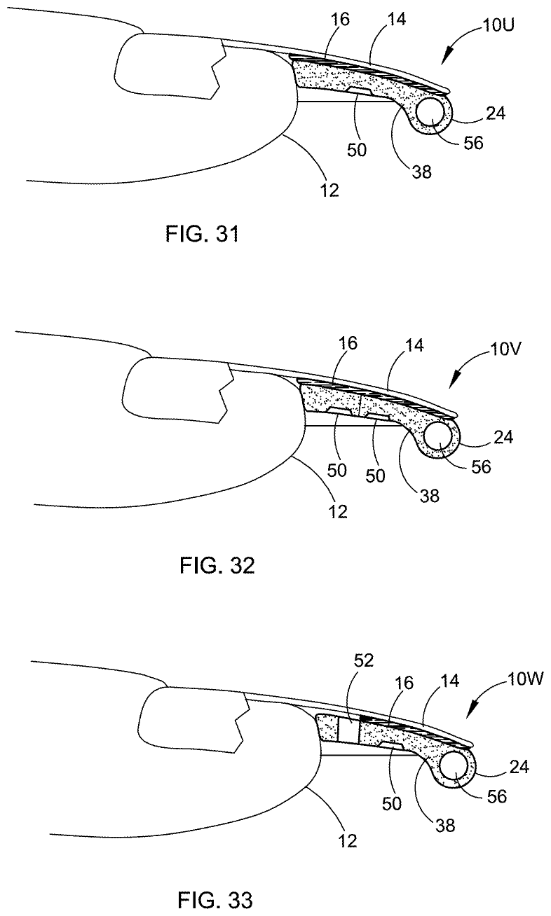

FIG. 31 depicts a side cutaway view of a Fingernail Attachable Capacitive Stylus 10U with a one-piece construction using a direct method of connecting the pieces together underneath the finger end 12 and fingernail or an artificial nail 14 using adhesive 16, illustrating that the Fingernail Attachable Capacitive Stylus 10U of the present invention may have forceps accepting grooves 50 and a bulbous end 24 including a hollow compression pocket 56 in the conductive material 38.

FIG. 32 depicts a side cutaway view of a Fingernail Attachable Capacitive Stylus 10V with a two-piece construction using a direct method of connecting the pieces together underneath the finger end 12 and fingernail 14 using adhesive 16 and an artificial fingernail, illustrating that the Fingernail Attachable Capacitive Stylus 10V of the present invention may have forceps accepting grooves 50 in each piece of the conductive material 38 and a bulbous end 24 including a hollow compression pocket 56 in the conductive material 38.

FIG. 33 depicts a side cutaway view of a Fingernail Attachable Capacitive Stylus 10W with a one-piece construction using a direct method of connecting the piece underneath the finger end and fingernail 12 or an artificial nail 14 using adhesive 16, illustrating that the Fingernail Attachable Capacitive Stylus 10W of the present invention may have compression cavity 52 located near the fingertip, forceps grooves 50 incorporated into the one-piece of conductive material 38 and a bulbous end 24 including a hollow compression pocket 56 in the conductive material 38.

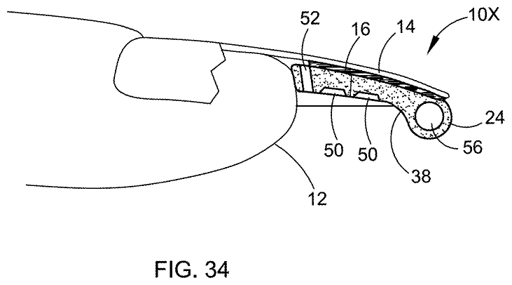

FIG. 34 depicts a side cutaway view of a Fingernail Attachable Capacitive Stylus 10X with a two-piece construction using a direct method of connecting the pieces together underneath the finger end 12 and fingernail or an artificial nail 14 using adhesive 16, illustrating that the Fingernail Attachable Capacitive Stylus 10X of the present invention may have compression cavity 52, forceps grooves 50 incorporated into both pieces of conductive material 38, and a bulbous end 24 including a hollow compression pocket 56 in the conductive material 38.

The Fingernail Attachable Capacitive Stylus 10A through 10X shown in the drawings and described in detail herein disclose arrangements of elements of particular construction and configuration for illustrating preferred embodiments of structure and method of operation of the present application. It is to be understood, however, that elements of different construction and configuration and other arrangements thereof, other than those illustrated and described may be employed for providing the Fingernail Attachable Capacitive Stylus 10A through 10X in accordance with the spirit of this disclosure, and such changes, alternations and modifications as would occur to those skilled in the art are considered to be within the scope of this design as broadly defined in the appended claims.

While certain embodiments of the Fingernail Attachable Capacitive Stylus have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. For example, one portion of one of the embodiments described herein can be substituted for another portion in another embodiment described herein. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Further, the purpose of the foregoing abstract is to enable the U.S. Patent and Trademark Office, foreign patent offices worldwide and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured, by the claims, nor is it intended to be limiting as to the scope of the invention in any way.

I claim:

1. A fingernail attachable capacitive stylus, comprising:
(a) one or more pieces of conductive material configured to be attached to the underside of an artificial fingernail or natural fingernail;
(b) at least one of said one or more pieces of conductive material having a proximal end configured to make contact with the user's finger skin;
(c) at least one of said one or more pieces of conductive material having a distal end configured to make contact with a touch screen; and
(d) a compression cavity formed from compressible sides of conductive material located between said proximal end and said distal end of said one or more pieces of capacitive material;
wherein when said one or more pieces of conductive material are mounted on a user's fingernail the proximal end makes contact with the user's finger skin and the compression cavity sides compress to compensate for a user's natural fingernail growth, the distal end makes contact with a touch screen and the compression pocket can compress and amorphous to compensate for the pressure applied by the user's finger to the touch screen when the fingernail attached stylus is in use.

2. The fingernail attachable capacitive stylus according to claim 1, wherein said one or more pieces of conductive material includes a single piece of conductive material configured to be directly mounted on an artificial fingernail and a user's natural fingernail.

3. The fingernail attachable capacitive stylus according to claim 1, wherein said one or more pieces of conductive material includes two pieces of conductive material capable of being cut to varying length and varying shape to adjust for a user's finger.

4. The fingernail attachable capacitive stylus according to claim 1, wherein said one or more pieces of conductive material includes three pieces of conductive material capable of being cut to varying length and varying shape to adjust for a user's finger.

5. The fingernail attachable capacitive stylus according to claim 1, wherein said one or more pieces of conductive material includes four pieces of conductive material capable of being cut to varying length and varying shape to adjust for a user's finger.

6. The fingernail attachable capacitive stylus according to claim 1, wherein said one or more pieces of conductive material includes conductive material configured to have forceps accepting grooves therein.

7. The fingernail attachable capacitive stylus according to claim 1, wherein said one or more pieces of conductive material includes two pieces of capacitive material, and further wherein both of said two pieces of conductive material each have forceps accepting grooves therein.

8. The fingernail attachable capacitive stylus according to claim 1, wherein said one or more pieces of conductive material having a distal end configured to make contact with a touch screen includes a button end, a bulbous end and a pointed end.

9. The fingernail attachable capacitive stylus according to claim 1, wherein said one or more pieces of conductive material includes a glue pocket and is adhered to an artificial fingernail before being mounted on the user's natural fingernail.

10. The fingernail attachable capacitive stylus, comprising:
(a) one or more pieces of conductive material configured to be attached to the underside of a natural fingernail;
(b) at least one of said one or more pieces of conductive material having a proximal end configured to make contact with the user's finger skin;
(c) at least one of said one or more pieces of conductive material having a distal end configured to make contact with a touch screen; and
(d) a compression pocket located within the conductive material at said distal end configured to make contact with a touch screen;
wherein when said one or more pieces of conductive material are mounted on a user's fingernail the proximal end makes contact with the user's finger skin, the distal end makes contact with a touch screen and the compression pocket compresses to compensate for the pressure applied by the user's finger to the touch screen when the fingernail attached stylus is in use.

11. The fingernail attachable capacitive stylus according to claim 10, wherein said one or more pieces of conductive material includes two pieces of conductive material and further wherein said proximal end is configured as a compression spring formed from conductive material and makes contact with the user's finger skin.

12. A method for making a fingernail attachable capacitive stylus, comprising the steps of:
(a) providing one or more pieces of conductive material configured to be attached to the underside of a natural fingernail;
(b) providing at least one of said one or more pieces of conductive material having a proximal end configured to make contact with the user's finger skin;
(c) providing at least one of said one or more pieces of conductive material having a distal end configured to make contact with a touch screen;
(d) providing a compression cavity formed from compressible sides of conductive material located between said proximal end and said distal end of said one or more pieces of capacitive material; and
(e) providing a compression pocket located within the conductive material at said distal end configured to make contact with a touch screen;
wherein when said one or more pieces of conductive material are mounted on a user's fingernail the proximal end makes contact with the user's finger skin, the distal end makes contact with a touch screen and the compression cavity sides compress to compensate for the pressure applied by the user's finger to the touch screen, and said compression pocket compresses to compensate for pressure applied by the user's finger to the touch screen, when the fingernail attached stylus is in use.

13. The method of making a fingernail attachable capacitive stylus according to claim 12, wherein said one or more pieces of conductive material includes a single piece of conductive material configured to be directly mounted on an artificial fingernail and a user's natural fingernail.

14. The method of making a fingernail attachable capacitive stylus according to claim 12, wherein said one or more pieces of conductive material includes a glue pocket and is adhered to an artificial fingernail before being mounted on the user's natural fingernail.

15. The method of making a fingernail attachable capacitive stylus according to claim 12, wherein said one or more pieces of conductive material includes two pieces of conductive material capable of being cut to length to adjust for a user's natural fingernail growth.

16. The method of making a fingernail attachable capacitive stylus according to claim 12, wherein said one or more pieces of conductive material includes three pieces of capacitive material.

17. The method of making a fingernail attachable capacitive stylus according to claim 12, wherein said one or more pieces of conductive material includes four pieces of capacitive material.

18. The method of making a fingernail attachable capacitive stylus, according to claim 12, wherein a compression spring formed from conductive material is located between said proximal end and said distal end of said one or more pieces of capacitive material, wherein when said one or more pieces of conductive material are mounted on a user's fingernail the proximal end makes contact with the user's finger skin, the distal end makes contact with a touch screen and the compression spring compresses to compensate for the pressure applied by the user's finger to the touch screen when the fingernail attached stylus is in use.

19. The method of making a fingernail attachable capacitive stylus according to claim 17, wherein said one or more pieces of conductive material includes two pieces of conductive material and further wherein said proximal end is configured as a compression spring formed from conductive material and makes contact with the user's finger skin.

20. The method of making a fingernail attachable capacitive stylus according to claim 12, wherein said at least one of said one or more pieces of material having a distal end configured to make contact with a touch screen includes a button end, a bulbous end and a pointed end.
